(19) United States
(12) Patent Application Publication
(10) Pub. No.: US 2026/0148596 A1
(43) Pub. Date: May 28, 2026

(54) Trusted-User Enrollment via Fingerprinting

(71) Applicant: Google LLC, Mountain View, CA (US)

(72) Inventor: Justin Douglas Eltoft, Pleasant Prairie, WI (US)

(73) Assignee: Google LLC, Mountain View, CA (US)

(21) Appl. No.: 19/410,374

(22) Filed: Dec. 5, 2025

Related U.S. Application Data
(60) Provisional application No. 63/931,062, filed on Dec. 4, 2025.

(51) Int. Cl. G07C 9/00; G06V 40/12; G06V 40/13; G06V 40/50

(52) U.S. Cl. CPC G07C 9/00174; G06V 40/13; G06V 40/1365; G06V 40/50; G07C 2209/02; G07C 2209/63

(57) ABSTRACT

Streamlined fingerprint enrollment of a trusted user on an electronic device is disclosed to address lengthy and difficult approaches to such enrollment. An apparatus includes one or more fingerprint sensors and associated logic to detect a first fingerprint corresponding to an authenticated primary user and a second fingerprint from another individual. Upon determining that the first and second fingerprints are jointly exposed to the fingerprint sensor, the logic enrolls the second fingerprint as corresponding to a trusted user. The joint exposure may be realized, for example, by simultaneous contact on a single, large-area sensor or by exposing the second fingerprint within a predetermined time period following the first. The enrollment may be completed with fewer scans than a standard procedure, and a template generated from the scans can be updated over time with subsequent authentications. The trusted user's access can also be bounded by temporal or geospatial constraints.

### CROSS-REFERENCE TO RELATED APPLICATION

This application claims the benefit of U.S. Provisional Patent Application No. 63/931,062 filed on 4 Dec. 2025, the disclosure of which is hereby incorporated by reference herein in its entirety.

### SUMMARY

This document describes hardware and techniques for streamlined fingerprint enrollment of a trusted user on an electronic device. The described systems and methods provide an efficient and low-friction alternative to other enrollment procedures, which typically require a user to perform numerous, distinct touches on a fingerprint sensor to create a robust fingerprint template. Other enrollment procedures also entail engaging in a carefully orchestrated dance to obtain fingerprints from a primary user and a new trusted user. By simplifying the enrollment process for a new trusted user, a primary user of the device can more conveniently grant temporary or long-term access to another individual.

In example implementations, an apparatus includes at least one fingerprint sensor and associated logic. The logic can detect a first fingerprint corresponding to an authenticated primary user and a second fingerprint from another individual. The logic attempts to determine that the first and second fingerprints are jointly exposed to the fingerprint sensor. Based on a determination that the first fingerprint corresponds to the primary user and the determination of joint fingerprint exposure, the logic enrolls the second fingerprint as corresponding to a trusted user. This enrollment may also be completed using significantly fewer scans of the second fingerprint than a standard enrollment process, and a template generated from the fewer scans can be updated over time (e.g., refined or fine-tuned) with subsequent authentications by the trusted user.

The joint exposure of the fingerprints may be realized in various ways. In some cases, the primary user and the trusted user simultaneously touch a contact surface of a single, large-area fingerprint sensor. In other cases, the logic may activate a trusted-user enrollment mode in which the new trusted user's fingerprint is exposed to the sensor within a predetermined time period after the primary user's fingerprint is detected. Furthermore, the enrollment of the trusted user can be bounded by one or more constraints. For example, the primary user may apply a temporal constraint to grant access for a limited duration or a geospatial constraint to grant access while the device remains within a specified geospatial area.

In example implementations, an apparatus for trusted-user enrollment via fingerprinting is described. The apparatus includes one or more fingerprint sensors and logic coupled to the one or more fingerprint sensors. The one or more fingerprint sensors are configured to sense one or more fingerprints and generate one or more representations respectively corresponding to the one or more fingerprints. The logic is configured to detect a first fingerprint of the one or more fingerprints and to detect a second fingerprint of the one or more fingerprints, the second fingerprint different from the first fingerprint. The logic is also configured to determine that the first fingerprint corresponds to a primary user and to determine that the first fingerprint and the second fingerprint are jointly exposed to the one or more fingerprint sensors. The logic is further configured to enroll, using the one or more representations, the second fingerprint as corresponding to a trusted user responsive to the determination that the first fingerprint corresponds to the primary user and the determination that the first fingerprint and the second fingerprint are jointly exposed to the one or more fingerprint sensors.

In example implementations, a method for trusted-user enrollment via fingerprinting is described. The method includes sensing, by one or more fingerprint sensors, one or more fingerprints and generating, by the one or more fingerprint sensors, one or more representations respectively corresponding to the one or more fingerprints. The method also includes detecting, by logic, a first fingerprint of the one or more fingerprints and a second fingerprint of the one or more fingerprints, with the second fingerprint different from the first fingerprint. The method additionally includes determining, by the logic, that the first fingerprint corresponds to a primary user. The method also includes determining, by the logic, that the first fingerprint and the second fingerprint are jointly exposed to the one or more fingerprint sensors. The method further includes enrolling, by the logic and using the one or more representations, the second fingerprint as corresponding to a trusted user responsive to the determining that the first fingerprint corresponds to the primary user and the determining that the first fingerprint and the second fingerprint are jointly exposed to the one or more fingerprint sensors.

In example implementations, a non-transitory computer-readable medium storing instructions that, when executed by one or more processors, cause the one or more processors to perform operations is described. The operations include sensing, using one or more fingerprint sensors, one or more fingerprints and generating, using the one or more fingerprint sensors, one or more representations respectively corresponding to the one or more fingerprints. The operations also include detecting a first fingerprint of the one or more fingerprints and a second fingerprint of the one or more fingerprints, with the second fingerprint different from the first fingerprint. The operations additionally include determining that the first fingerprint corresponds to a primary user. The operations also include determining that the first fingerprint and the second fingerprint are jointly exposed to the one or more fingerprint sensors. The operations further include enrolling, using the one or more representations, the second fingerprint as corresponding to a trusted user responsive to the determining that the first fingerprint corresponds to the primary user and the determining that the first fingerprint and the second fingerprint are jointly exposed to the one or more fingerprint sensors. Other implementations are described herein.

### BRIEF DESCRIPTION OF DRAWINGS

Apparatuses of and techniques for trusted-user enrollment via fingerprinting are described with reference to the following drawings. The same numbers are used throughout the drawings to reference like features and components.

FIG. 1 illustrates example apparatuses having a fingerprint sensor and associated logic to implement trusted-user enrollment via fingerprinting as described herein.

FIG. 2 is a schematic diagram illustrating an example fingerprint-based authorization system that can use a fingerprint sensor and associated logic to authorize a user based on a fingerprint thereof in accordance with trusted-user enrollment via fingerprinting.

FIG. 3 is a schematic diagram illustrating an example two-finger technique for enrolling a fingerprint of a trusted user in accordance with trusted-user enrollment via fingerprinting.

FIG. 4 is a schematic diagram illustrating example enrollment constraints with respect to a trusted user in accordance with trusted-user enrollment via fingerprinting.

FIG. 5-1 illustrates an example user-interface scheme to facilitate obtaining accurate fingerprints for trusted-user enrollment via fingerprinting.

FIG. 5-2 illustrates an example time-based scheme to jointly expose multiple fingerprints to enroll a trusted user in accordance with trusted-user enrollment via fingerprinting.

FIG. 6 illustrates various components of an example electronic device that can implement trusted-user enrollment via fingerprinting in accordance with one or more described aspects.

### DETAILED DESCRIPTION

### Overview

Electronic devices provide features and perform functions to make important contributions to modern society, such as those related to communication, safety, manufacturing, content creation, and information technology generally. Many of these contributions depend, at least partially, on the ability of the devices to remain secure for a primary user. Electronic devices, such as mobile phones, tablet computers, and wearable devices, are commonly equipped with security features to control access to the device and the data stored thereon. One prevalent security feature is biometric authentication, which uses a person's unique physiological characteristics to verify their identity. Fingerprint sensing is a widely adopted form of biometric authentication due to its convenience and reliability. Various types of fingerprint sensors are utilized in electronic devices, including capacitive, optical, and ultrasonic sensors, which sensors may be located on the rear, side, or integrated under the display of a device.

To use fingerprint authentication, a user first completes an enrollment process. This process typically involves capturing multiple images or other representations of a user's fingerprint. The user is prompted to place and reposition a finger on a contact surface of the fingerprint sensor numerous times. This multitouch procedure allows the system to capture different portions of the fingerprint from various angles, which are then processed and combined to create a robust digital template of the fingerprint. This template is stored securely on the device and is subsequently used as a reference for authenticating the user during login or other access-controlled operations.

Many electronic devices support multiple user profiles or levels of access. A device may have a primary user, such as the owner, who has full administrative privileges. The primary user may wish to grant access to other individuals, who can be designated as trusted users, such as family members or friends. This allows the trusted user to operate the device, often with a set of permissions or restrictions defined by the primary user.

When a primary user decides to authorize a trusted user via fingerprint authentication, the trusted user is typically required to undergo the same standard enrollment process. The trusted user must interact with the fingerprint sensor through the multitouch procedure to generate a “full” fingerprint template for storage on the device. This requirement exists regardless of whether the intended access for the trusted user is for a limited duration or for long-term use. Generally, the lengthy, multitouch enrollment procedure is a prerequisite for any user, primary or trusted, to be authenticated using their fingerprint. Further, there is typically a complicated interplay between when the primary user is authenticated via fingerprint sensing to enable the enrollment process to proceed and when the trusted user may begin the extensive multi-touch fingerprint-sensing procedure. These issues at least reduce how frequently a primary user is willing to create a trusted user for their device.

To address the friction associated with convoluted enrollment processes, including a multistep fingerprint enrollment procedure, for secondary users, this document describes hardware and techniques for a streamlined and secure process for such enrollment. The described approaches enable a primary user to authorize a trusted user quickly and conveniently. The primary user can also institute enhanced control over the scope of the secondary access. Multiple example implementations are described herein.

In some implementations, a trusted user is enrolled through a joint, even simultaneous, action with an authenticated primary user. An apparatus can include a large-area fingerprint sensor, for instance on the rear of the device, that is capable of sensing at least two fingerprints at the same time. After associated logic determines that a first fingerprint corresponds to an already-enrolled primary user, and that a second fingerprint from another individual is being jointly exposed to the fingerprint sensor with the first fingerprint, the logic enrolls the second fingerprint as corresponding to a trusted user. This approach provides an advantage of being a clear, intentional, and low-friction authorization act because it involves the joint physical presence and consent of both users. To prevent accidental or malicious enrollment, the logic can deny enrollment if the fingerprints are not determined to be jointly exposed under the specified criterion.

The enrollment process can be further streamlined by utilizing significantly fewer scans than a lengthy, multitouch procedure. For example, the logic can enroll the trusted user with fewer than three or four scans of their fingerprint, such as one or two. From these limited scans, the logic generates an initial fingerprint template. While this initial template is sufficient for authentication, its robustness can be improved over time. The logic can be configured to update the template using one or more additional scans of the trusted user's fingerprint captured during subsequent successful authentications. This technique provides an advantage of a rapid and convenient initial setup for the trusted user, while still developing a highly reliable and secure authentication template over the course of its use.

To provide the primary user with greater control and security, the trusted user's enrollment can be bounded by one or more constraints. For instance, a primary user can apply a temporal constraint to grant access for a limited duration, after which the trusted user's authorization is automatically terminated. Additionally or alternatively, a geospatial constraint can be applied to grant access while the device remains within a specified geospatial area (e.g., an area where the enrollment occurred) or in proximity to another device associated with the primary user. If the geospatial constraint is violated, operational authorization for the trusted user is terminated. An advantage of these constraints is that the primary user can grant temporary or situational access without compromising long-term device security or privacy or needing to remember to manually terminate the access.

In some cases, such as on devices with smaller fingerprint sensors that cannot accommodate two fingers at once, a similar streamlined enrollment can be achieved sequentially. The logic can activate a trusted-user enrollment mode after the primary user authenticates. This opens a predetermined time period, after the primary user has touched the fingerprint sensor, during which the trusted user can expose their fingerprint to the sensor to be enrolled. This provides an advantage of extending the streamlined enrollment capability to a wider range of device hardware.

To further facilitate the streamlined process, especially with under-display fingerprint sensors, a user interface can provide visual guidance for accurate finger placement. The logic can cause the display to render a visual indicator, such as a ring that outlines the boundary of the sensor and an icon within the ring. The icon indicates the fingerprint-sensing function. An advantage of this guidance or feedback is an improved likelihood of capturing a high-quality fingerprint scan on the first or second attempt, which is helpful for an enrollment process that may rely on fewer scans.

Thus, example implementations enable a more-efficient, convenient, and secure method for a primary user to grant fingerprint-based access to a trusted user. These techniques can reduce the friction of other enrollment processes and provide the primary user with granular control over access permissions. The techniques are also adaptable to various hardware configurations. Other advantages are described herein.

### Example Environments and Electronic Devices

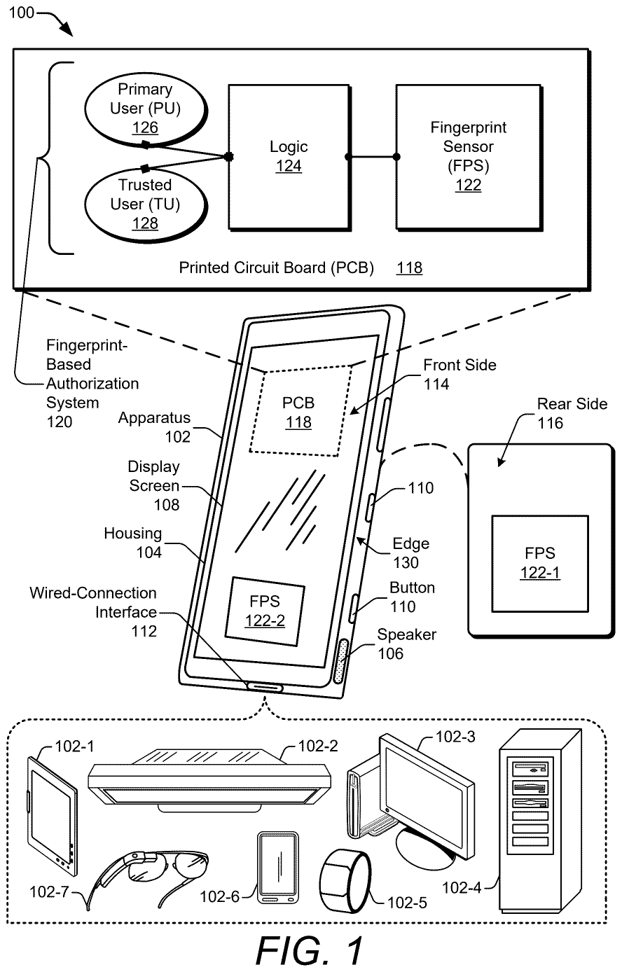

FIG. 1 illustrates, at 100 generally, an example apparatus 102 that includes at least one fingerprint sensor 122 (FPS) and associated logic 124 that can implement trusted-user enrollment via fingerprinting as described herein. As shown, the apparatus 102 includes at least one printed circuit board (PCB) 118 or another support structure for electrical components. The printed circuit board 118 can be realized, for instance, with a printed wiring board having multiple layers that are conductive or insulating. In some cases, the layers are alternated and sandwiched together into a laminate structure. Traces, planes, wires, and so forth can also be etched or otherwise disposed on one or more of the layers. The printed circuit board 118 may be rigid or flexible and may be formed from various materials.

Circuit components can be mounted on either or both sides of the structure of the printed circuit board 118 or at any layer thereof. Examples of such circuit components include the fingerprint sensor 122 and at least one instance of logic 124. Circuit components can also be mounted on other parts of the apparatus 102. For example, the housing 104 or a frame (not shown) of the apparatus 102 can support circuit components. The housing 104 may be formed from a single piece of material or from multiple pieces of material.

As shown, the apparatus 102 can include other components and aspects that are visible externally. For example, the apparatus 102 can include at least one speaker 106, at least one display screen 108, at least one button 110, and at least one wired-connection interface 112. The apparatus 102 may have multiple sides, like at least one front side 114, at least one rear side 116, at least one edge 130, and so forth. For some form factors, like foldable or clamshell devices, the apparatus 102 may include, for instance, more than one front side 114, or a portion of the apparatus 102 may be a front side 114 in one state and a rear side 116 in another state. Generally, in any given state, the front side 114 is opposite the rear side 116. In some cases, the front side 114 may have the sole display screen 108 or may have the larger (including largest) display screen 108 between the two or more sides. Similarly, the rear side 116 may have the sole camera array or assembly (not shown) or may have the larger camera array or assembly between the two or more sides.

In example implementations, the apparatus 102 includes a fingerprint-based authorization system 120 that enables one or more users of the apparatus 102 to be permitted to operate the apparatus 102 based on fingerprint identification. The fingerprint-based authorization system 120 can authenticate a user based on fingerprint identification once the user has enrolled at least one fingerprint. The apparatus 102 may offer multiple levels of access or authorization to users. Two example levels are primary user 126 (PU) and trusted user 128 (TU). These user authorization levels can be defined in any manner. By way of example only, a primary user 126—like the owner—can be granted full access to the functions of the apparatus 102. A trusted user 128—like a friend or family member of the owner—can be granted partial or limited access to the functions of the apparatus 102. To do so, the apparatus 102 can use the fingerprint-based authorization system 120, including the fingerprint sensor 122 and logic 124 thereof, to enroll the trusted user 128 with some level of device access as is described herein.

Thus, to enable fingerprint-based authorization, the apparatus 102 can include one or more fingerprint sensors 122. As shown in FIG. 1, however, the apparatus 102 includes multiple fingerprint sensors 122: a first fingerprint sensor 122-1 and a second fingerprint sensor 122-2. The first fingerprint sensor 122-1 is disposed on the rear side 116 of the apparatus 102. The second fingerprint sensor 122-2 is disposed on the front side 114 of the apparatus 102. The second fingerprint sensor 122-2 can be realized using, for instance, an under-display fingerprint sensor (UDFPS) if the second fingerprint sensor 122-2 and the display screen 108 are layered over one another. Types of fingerprint sensors 122 include capacitive fingerprint sensors 122, ultrasonic fingerprint sensors 122, optical fingerprint sensors 122, total internal reflection based optical fingerprint sensors 122, thermal fingerprint sensors 122, and so forth. The first fingerprint sensor 122-1 can be implemented in any manner, partially depending on what other components are present at the rear side 116.

In this example, the apparatus 102 is depicted as a smartphone. The apparatus 102 may, however, be implemented as any suitable computing or other electronic device as described herein. Examples of the apparatus 102 include a mobile electronic device or mobile device, mobile communication device, modem, cellular or mobile phone, mobile station, user terminal (e.g., for satellite, cellular, or wireless ethernet), gaming device, navigation device, media or entertainment device (e.g., a media streamer or gaming controller), laptop computer, desktop computer, tablet computer, smart appliance, vehicle-based electronic system, wearable computing device (e.g., clothing, watch, or augmented-reality glasses), Internet of Things (IoTs) device, sensor, stock management device, electronic portion of a machine or item of equipment (e.g., a vehicle or robot), memory storage device (e.g., a solid-state drive (SSD)), server computer or portion thereof (e.g., a server blade or rack or another part of a datacenter), and the like.

Illustrated examples of the apparatus 102 include a tablet device 102-1, a smart television 102-2, a desktop computer 102-3, a server computer 102-4, a smartwatch 102-5, a smartphone (or document reader) 102-6, and intelligent glasses 102-7 (e.g., virtual or mixed reality glasses). Other examples of apparatuses 102 include smartphones and tablets, wearable devices (e.g. smartwatches, fitness trackers, and intelligent glasses), portable gaming devices, e-readers, portable audio devices (e.g., wireless earbuds and portable speakers), user terminals, and ruggedized portable devices generally.

### Example Apparatuses and Operational Schemes

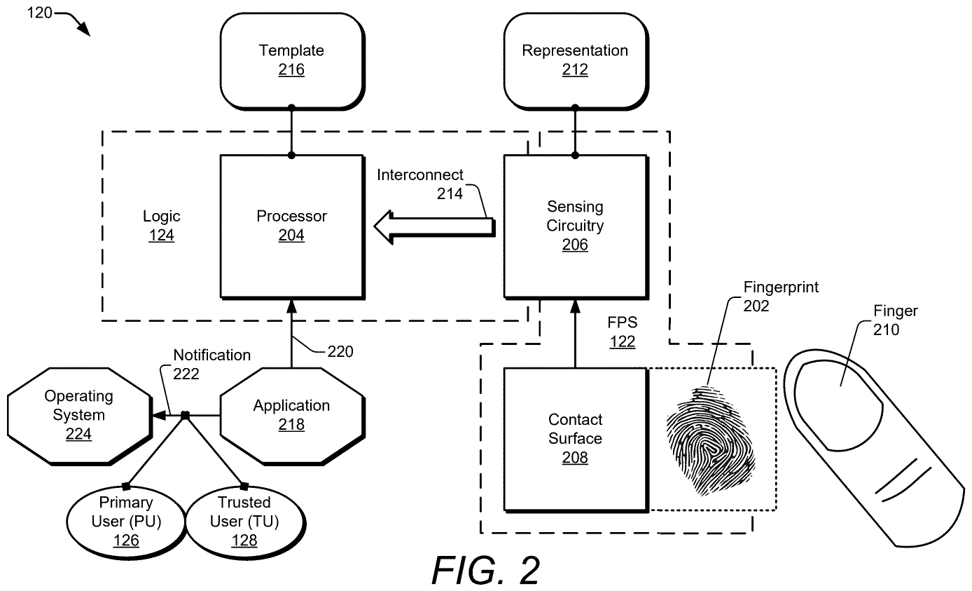

FIG. 2 illustrates a schematic diagram of an example fingerprint-based authorization system 120 that can use a fingerprint sensor 122 and associated logic 124 to authorize a user based on a fingerprint 202 thereof. As illustrated, the fingerprint-based authorization system 120 can include at least one processor 204, at least one instance of sensing circuitry 206, and at least one contact surface 208. In some cases, the fingerprint sensor 122 can include the contact surface 208 and at least a portion of the sensing circuitry 206. The logic 124 can include the processor 204 and at least a portion of the sensing circuitry 206. However, in other cases, the fingerprint sensor 122 or the logic 124 may be realized differently. For instance, the logic 124 may include all the sensing circuitry 206 or none of the sensing circuitry 206.

In operation, a user presses their finger 210 against the contact surface 208 of the fingerprint sensor 122 to expose the fingerprint 202 of the finger 210 to the fingerprint sensor 122. The contact surface 208 can be any material, including glass, plastic, or metal. In example implementations, the sensing circuitry 206 senses (e.g., obtains, detects, or reads) at least one representation 212 of the fingerprint 202. With an optical fingerprint sensor 122, for example, the sensing circuitry 206 can include at least one camera or other optical sensor. With a capacitive fingerprint sensor 122, the sensing circuitry 206 can include multiple capacitive elements that are sensitive to the capacitance of human skin, which varies between the ridges and valleys of the fingerprint 202 due to differences in distance to the sensor plates. Generally, the representation 212 may be realized as a set of digital data that reproduces the ridges and valleys of the fingerprint 202 using a sensing mechanism. In at least an optical context, the representation 212 may be referred to as an image.

The sensing circuitry 206 can be coupled to the processor 204 via at least one interconnect 214. The interconnect 214 can be realized using a secure bus protocol, like a Serial Peripheral Interface (SPI) bus protocol. The sensing circuitry 206 transfers the representation 212, which is analogous to raw image data, to the processor 204. The processor 204 analyzes the representation 212 and produces at least one template 216, which is analogous to a vector representation of raw image data. The template 216 includes sufficient information to uniquely identify the corresponding fingerprint 202. This information may include minutiae, or points on the fingerprint 202 that can contribute to the uniqueness of the fingerprint pattern. The template 216 can occupy less memory than the representation 212 or be simpler to compare against a newly acquired fingerprint 202.

As shown at 220, an application 218 can direct the logic 124 (e.g., the processor 204 or the sensing circuitry 206) to obtain a new template 216 for enrollment, to compare a new template 216 to one or more existing templates 216 for authentication, and so forth. The application 218 can be a trusted application, like one that operates in a trusted execution environment (TEE). Responsive to an affirmative authentication determination, the application 218 can provide a notification 222 to an operating system 224. The notification 222 may include an indication that a newly obtained template 216 corresponding to a sensed fingerprint 202 matches a stored template 216 of an enrolled user.

The operating system 224 may be blocked from accessing the representation 212 and the template 216 to keep the user's fingerprints private and secure. Generally, fingerprint data can be handled within the Trusted Execution Environment (TEE) and the stored templates 216 can be encrypted. The high-level operating system can be limited to only receiving a pass/fail or match/no-match notification, while being excluded from accessing the raw biometric data. This provides a complete secure system for handling the fingerprint data.

In some cases, the authentication determination can link a newly obtained template 216 to a primary user 126 or a trusted user 128. Each of these users, however, is enrolled before the subsequent authentication determination can be made. Example techniques to enroll a fingerprint 202 of a trusted user 128 in a quick and efficient manner are described next.

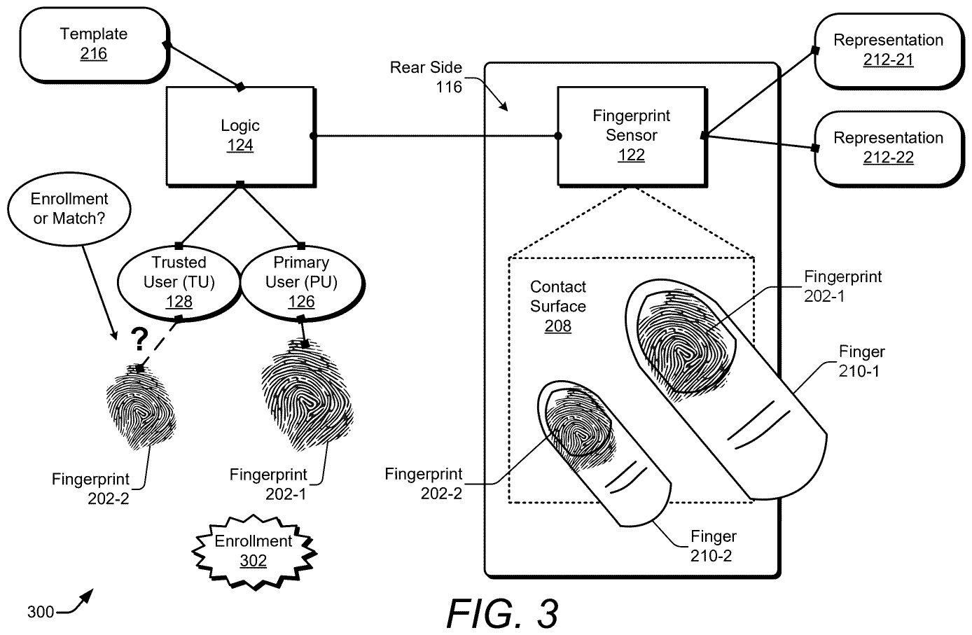

FIG. 3 illustrates a schematic diagram 300 of an example two-finger technique for enrolling a fingerprint 202 of a trusted user 128 in accordance with trusted-user enrollment via fingerprinting. Each finger 210 can have a respective fingerprint 202. Thus, a first finger 210-1 includes a first fingerprint 202-1, and a second finger 210-2 includes a second fingerprint 202-2. At least two types of users, a primary user 126 and a trusted user 128, are available for this device, but a device may offer more or different types of users.

In example implementations, one or more fingerprint sensors 122 can sense one or more fingerprints 202 and generate one or more representations 212 respectively corresponding to the one or more fingerprints 202. The logic 124 is coupled to the fingerprint sensor 122 and configured to detect one or more fingerprints 202. As shown, the logic 124 can detect the first fingerprint 202-1 of the one or more fingerprints 202 and detect the second fingerprint 202-2 of the one or more fingerprints 202. The logic 124 can determine that the first fingerprint 202-1 corresponds to the primary user 126, who was previously enrolled.

The logic 124 can also determine that the first fingerprint 202-1 and the second fingerprint 202-2 are jointly exposed to the fingerprint sensor 122. In some cases, joint exposure entails the fingerprint sensor 122 being able to capture the first and second fingerprints 202-1 and 202-2 in accordance with at least one specified criterion for how the first finger 210-1 and the second finger 210-2 enable the capturing. For example, there may be a timing aspect in which the first and second fingerprints 202-1 and 202-2 can be captured within a time window. Additionally or alternatively, there may be an order aspect in which the first fingerprint 202-1 is captured before the second fingerprint 202-2, in which the second fingerprint 202-2 is captured before the first fingerprint 202-1, or in which the first and second fingerprints 202-1 and 202-2 are captured substantially simultaneously. Further, the at least one specified criterion may include an aspect of where (e.g., which fingerprint sensor 122 or portion thereof) each fingerprint 202 is exposed.

The first fingerprint 202-1 can be previously linked to the status of the primary user 126. The logic 124 can enroll, using the one or more representations 212, the second fingerprint 202-2 as corresponding to the trusted user 128 based on the determination that the first fingerprint 202-1 corresponds to the primary user 126 and based on the determination that the first fingerprint 202-1 and the second fingerprint 202-2 are jointly exposed to the one or more fingerprint sensors 122 to create an enrollment 302. This joint exposure characteristic of the technique enables the primary user 126 to quickly enable another person to become a trusted user 128 with low friction. In some scenarios, however, the first and second fingerprints 202-1 and 202-2 may not be jointly exposed to the fingerprint sensor 122. To protect the primary user 126 from accidentally creating a new trusted user 128 (and to protect against malicious attempts by someone to become a new trusted user 128), the logic 124 can deny enrollment 302 to the second fingerprint 202-2 responsive to a determination that the first fingerprint 202-1 and the second fingerprint 202-2 are not jointly exposed to the one or more fingerprint sensors 122.

In some cases, the logic 124 may determine that the first fingerprint 202-1 and the second fingerprint 202-2 are simultaneously exposed to the one or more fingerprint sensors 122 to enable the enrollment 302 of the second fingerprint 202-2 as a trusted user 128. Here, simultaneous exposure can be achieved if, for example, the one or more fingerprint sensors 122 are able to sense at least a portion of the first fingerprint 202-1 and at least a portion of the second fingerprint 202-2 at the same time. The simultaneous exposure need not be continuous throughout the entire scan of each fingerprint 202 in some cases. As shown, the one or more fingerprint sensors 122 can include one or more contact surfaces 208. In such cases, the logic 124 can determine that the first fingerprint 202-1 and the second fingerprint 202-2 are simultaneously touching the one or more contact surfaces 208 of the one or more fingerprint sensors 122 for at least an instant to enable enrollment 302 of the second fingerprint 202-2 as corresponding to the trusted user 128.

In some implementations, the one or more fingerprint sensors 122 are realized as a single fingerprint sensor, as is shown in FIG. 3. By way of example only, the single fingerprint sensor can present a sufficiently sized contact surface 208 to be simultaneously exposed to at least two fingerprints 202, including the first fingerprint 202-1 and the second fingerprint 202-2. For sizing purposes, the corresponding first and second fingers 210-1 and 210-2 may be assumed to both be average adult sized fingers 210. Such a single fingerprint sensor may be, for instance, about 20×30 millimeters. This large-area sensor can be realized using, for instance, a total-internal-reflection-based optical fingerprint sensor implementation. As described with reference to FIG. 1, the apparatus 102 can include a front side 114 and a rear side 116 that is opposite the front side 114. The single fingerprint sensor may be disposed on the rear side 116 of the apparatus 102. With reference also to FIG. 1, the front side 114 can include the display screen 108. The rear side 116, in contrast, can lack a display screen or may include another display screen that is smaller than the display screen 108 of the front side 114.

However, these aspects can differ in other implementations. For example, the fingerprint sensor 122, whether single or otherwise, can be disposed on the front side 114, including with the fingerprint sensor 122 being disposed under the display screen 108. A rear-side fingerprint sensor 122 can be realized as an under-display fingerprint sensor (UDFPS). Further, the at least one fingerprint sensor 122 can be implemented as multiple fingerprint sensors, like a first fingerprint sensor 122-1 and a second fingerprint sensor 122-2 (e.g., as shown in FIG. 1). The first and second fingerprint sensors 122-1 and 122-2 can respectively sense the first and second fingerprints 202-1 and 202-2, or vice versa. The first and second fingerprint sensors 122-1 and 122-2 can be disposed on the same side of the apparatus 102 (not shown) or on different (e.g., opposite) sides (e.g., of FIG. 1). In some implementations, the fingerprint sensor 122 is disposed on the rear side 116 to enable authentication or enrollment while the apparatus 102 is placed face down on a surface (e.g., a table), thereby allowing for an ambient or non-intrusive interaction.

In some fingerprint-based authorization systems, enrollment may involve many scans and fingerprint samples. To ensure a good template can be built that enables correct fingerprint detection, the fingerprint sensor 122 may obtain various representations (e.g., 10-20 representations) of a finger from different angles and fingerprint portions. In contrast, described techniques enable enrollment 302 of a trusted user 128 with fewer scans, like half a dozen or fewer fingerprint scans.

Thus, in example implementations, the logic 124 can enroll the second fingerprint 202-2 as corresponding to the trusted user 128 with fewer than four scans of the second fingerprint 202-2 based on the determination that the first fingerprint 202-1 corresponds to the primary user 126 and the determination that the first fingerprint 202-1 and the second fingerprint 202-2 are jointly exposed to the at least one fingerprint sensor 122. Further, the logic 124 may enroll the second fingerprint 202-2 as corresponding to the trusted user 128 with fewer than three scans of the second fingerprint 202-2 based on the determination that the first fingerprint 202-1 corresponds to the primary user 126 and the determination that the first fingerprint 202-1 and the second fingerprint 202-2 are jointly exposed to the at least one fingerprint sensor 122.

In an example enrollment 302, the fingerprint sensor 122 may take two scans of the second fingerprint 202-2 to produce two representations 212 thereof: a first representation 212-21 and a second representation 212-22. With two representations 212 of the second fingerprint 202-2, the logic 124, as part of enrolling the second fingerprint 202-2 as corresponding to the trusted user 128 with fewer than three scans of the second fingerprint 202-2, can generate a template 216 for the second fingerprint 202-2 using a representation of each scan (e.g., the first and a second representations 212-21 and 212-22) from the fewer than three scans of the second fingerprint 202-2. However, the resulting template 216 is less robust than one that is built from relatively more scans. Accordingly, the logic 124 can update the template 216 (e.g., refine or fine-tune) using one or more additional scans of the second fingerprint 202-2 as the trusted user 128 authenticates with the second fingerprint 202-2 over time. This enables the template 216 to be more reliable over time.

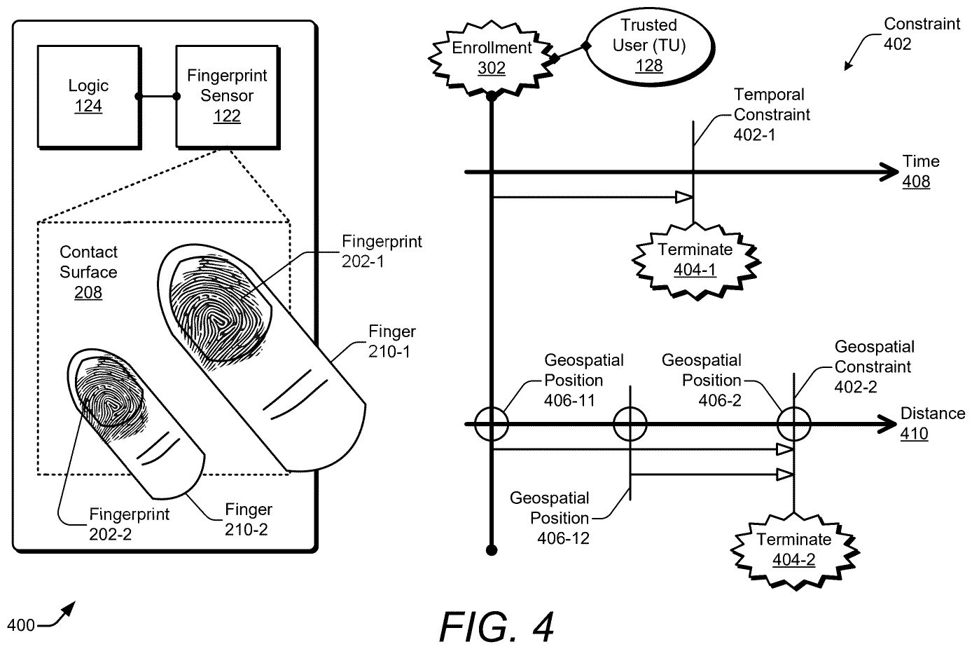

FIG. 4 illustrates a schematic diagram 400 of example enrollment constraints 402 of a trusted user 128 in accordance with trusted-user enrollment via fingerprinting. For any of several reasons, the enrollment 302 of the trusted user 128 may be bounded by one or more constraints 402. For example, the primary user 126 may want to limit under what circumstances or for how long the trusted user 128 has access to their device. Further, the trusted user 128 may prefer that representations 212 or a template 216 of their fingerprint 202 are automatically removed from the device of the primary user 126 in accordance with some criterion, which can be implemented with an enrollment constraint 402. Two example constraints 402 are depicted in FIG. 4: a temporal constraint 402-1 with respect to a time axis 408 and a geospatial constraint 402-2 with respect to a distance axis 410. When a trusted user's constrained access expires (e.g., due to time or location), their biometric data (e.g., a template 216) can be securely deleted from the device.

Generally, in example implementations, the logic 124 can bound the enrollment 302 of the second fingerprint 202-2 as corresponding to the trusted user 128 based on at least one of a temporal constraint 402-1 or a geospatial constraint 402-2. If the temporal constraint 402-1 is activated upon the enrollment 302—or at a subsequent time by the primary user 126 or the trusted user 128, the logic 124 can terminate 404-1 operational authorization for the trusted user 128 if the temporal constraint 402-1 is violated. For example, after a three-hour period expires, the logic 124 can terminate the ability of the trusted user 128 to unlock a device or to access certain features of an unlocked device.

If the geospatial constraint 402-2 is activated upon the enrollment 302—or at a subsequent time or place by the primary user 126 or the trusted user 128, the logic 124 can terminate 404-2 operational authorization for the trusted user 128 if the geospatial constraint 402-2 is violated. For example, the geospatial constraint 402-2 may be based on a distance between two geospatial positions: a first geospatial position 406-1 and a second geospatial position 406-2. If the distance between the first and second geospatial positions 406-1 and 406-2 exceeds the geospatial constraint 402-2, the constraint can be violated. The termination 404-2 can be similar to those examples provided above for the termination 404-1. As another example for a termination authorization 404, the device may initiate a protocol that enables the trusted user 128 to access or only an affirmatively identified subset of the available features or applications on the device.

Two examples for the first and second geospatial positions are described here. Generally, the second geospatial position 406-2 can correspond to a current geospatial position of the apparatus 102 in which the trusted user 128 has been enrolled, and the “base” or first geospatial position 406-1 can vary by implementation. In a first example, the geospatial constraint 402-2 is based on a geospatial position 406-11 of the apparatus 102 when the enrollment 302 of the second fingerprint 202-2 is performed and a current geospatial position 406-2 of the apparatus 102. This example can correspond to a scenario in which a parent wishes to authorize a child to have access to their device as a trusted user 128 while the apparatus 102 remains at home, or within 100 feet of their home. In a second example, the geospatial constraint 402-2 is based on a current geospatial position 406-12 of another apparatus that is linked to the primary user 126 and a current geospatial position 406-2 of the apparatus 102. This example can correspond to a scenario in which a parent wishes to authorize a child to have access to their smartphone device as a trusted user 128 while this apparatus 102 remains within 50 feet of a smartwatch for which the parent is also the primary user 126.

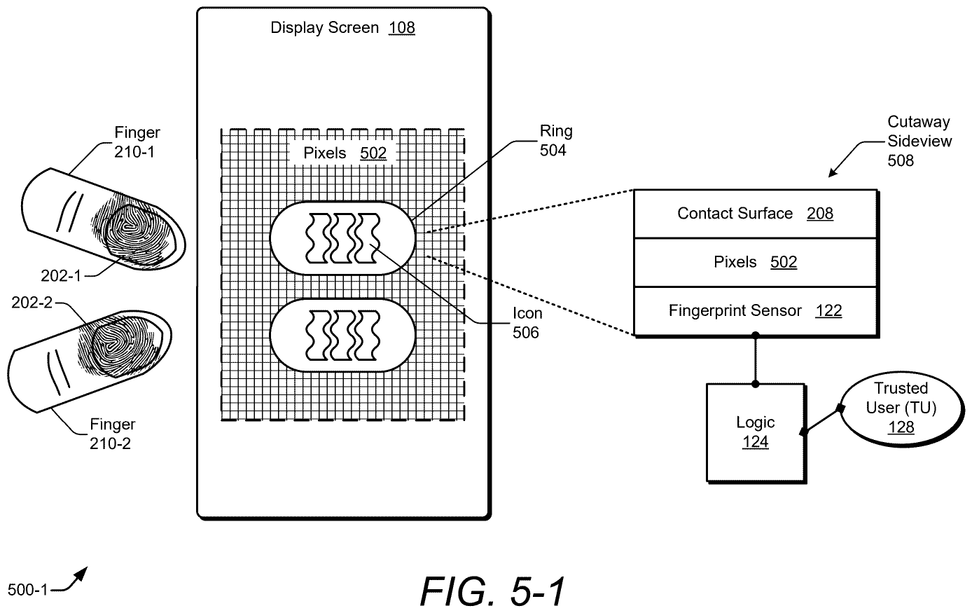

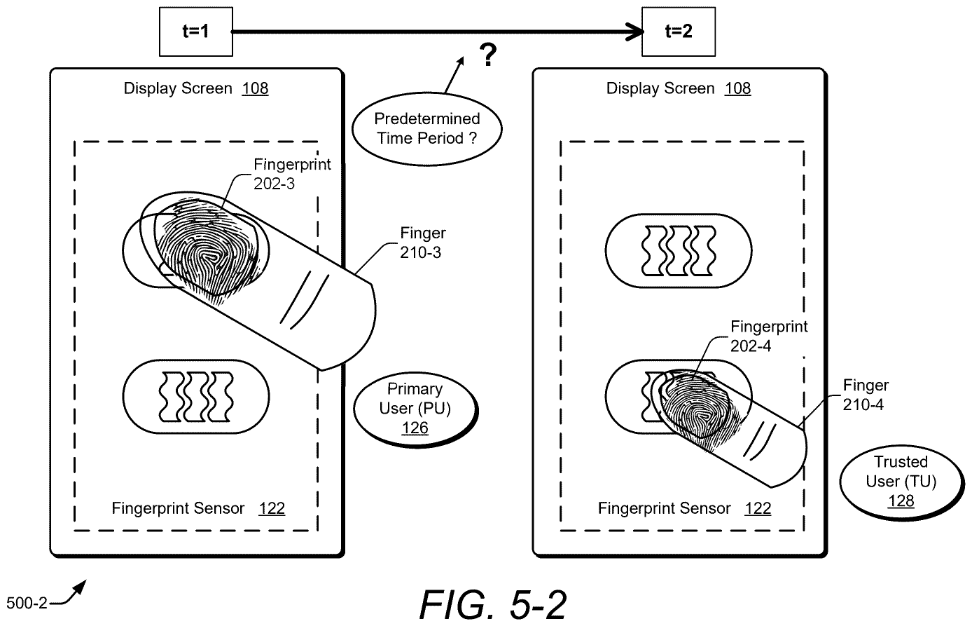

FIG. 5-1 illustrates an example user interface scheme 500-1 to facilitate obtaining accurate fingerprints for trusted-user enrollment via fingerprinting. As shown, the display screen 108 includes pixels 502. In this example, the fingerprint sensor 122 is implemented as an under-display fingerprint sensor. On the right side of FIG. 5-1, a cross-section view 508 depicts multiple example layers. The contact surface 208 covers the pixels 502 of the display screen 108. The fingerprint sensor 122 is disposed “under” the pixels 502 of the display screen 108. The pixels 502 of the display screen 108 can be used to display at least one ring 504 or at least one icon 506. The ring 504 and the icon 506 individually or jointly indicate where a finger 210 can be placed for a more accurate sensing of the fingerprints by the fingerprint sensor 122.

In example implementations, the apparatus 102 includes at least one display screen 108 having multiple pixels 502. The at least one fingerprint sensor 122 and the at least one display screen 108 are layered together such that the multiple pixels 502 of the display screen 108 are visible where the at least one fingerprint sensor 122 can sense one or more fingerprints 202-1 and 202-2. In operation, the logic 124 can display on the display screen 108 using at least some of the pixels 502 at least one ring 504 indicating at least one boundary around the at least one fingerprint sensor 122. Further, the logic 124 can display, within the at least one ring 504, at least one icon 506 indicating that a fingerprint 202 can be sensed within the at least one ring 504.

The ring 504 can indicate to the user where the fingerprint sensor 122 can sense a fingerprint 202 and where it cannot sense the fingerprint 202 via a visual boundary line. The icon 506 clearly indicates the purpose of the visual boundary line to further accelerate the sensing of a fingerprint 202 to quickly enroll a trusted user 128. In FIG. 5-1, two rings 504 and two icons 506 are depicted to facilitate the placement of two fingers 210. However, the described user interface features can be implemented in different manners. For example, the at least one ring 504 and the at least one icon 506 can be implemented as a single ring 504 with a single icon 506 or with two icons 506. As another alternative example, the ring 504 may be rectangular, octagonal, or another shape.

FIG. 5-2 illustrates an example time-based scheme 500-2 to jointly expose multiple fingerprints 202-3 and 202-4 to enroll a trusted user 128 in accordance with trusted-user enrollment via fingerprinting. In some cases, a trusted user 128 can be enrolled with a joint exposure of a third fingerprint 202-3 of a third finger 210-3 and a fourth fingerprint 202-4 of a fourth finger 210-4 by exposing the fingerprints sequentially (e.g., instead of overlapping for some period) but within a predetermined time period of each other. This feature can be enabled, for instance, by activating a trusted-user enrollment mode that enables sequential fingerprint sensing. For descriptive clarity relative to other implementations, the fingerprints are numbered differently; however, the third fingerprint 202-3 may be physically the same as the first fingerprint 202-1 (e.g., of other figures), and the fourth fingerprint 202-4 may be physically the same as the second fingerprint 202-2 (e.g., of other figures). In FIG. 5-2, the time period is compared to the amount of time that elapses between a first time (t=1) and a second time (t=2). If the fourth fingerprint 202-4 is sensed within the predetermined time period after the third fingerprint 202-3 is sensed, then the fourth fingerprint 202-4 can be enrolled as the trusted user 128. If, on the other hand, the time period elapses before the fourth fingerprint 202-4 is sensed, then the fourth fingerprint 202-4 is denied enrollment.

In example implementations, the logic 124 can activate a trusted-user enrollment mode that enables sequential fingerprint sensing. Based on the trusted-user enrollment mode being activated, the logic 124 can permit sequential sensing within a predetermined time period as follows. The logic 124 can detect the third fingerprint 202-3 and the fourth fingerprint 202-4 of one or more fingerprints 202. The logic 124 can determine that the third fingerprint 202-3 corresponds to the primary user 126. The logic 124 can also determine that the fourth fingerprint 202-4 is exposed to at least one fingerprint sensor 122 within a predetermined time period of the third fingerprint 202-3 being exposed to the fingerprint sensor 122. For example, the logic 124 can determine if the second time (t=2) minus the first time (t=1) is less than the predetermined time period.

If so, then the logic 124 can enroll the fourth fingerprint 202-4 as corresponding to a trusted user 128 responsive to the determination that the third fingerprint 202-3 corresponds to the primary user 126 and the determination that the fourth fingerprint 202-4 is exposed to the at least one fingerprint sensor 122 within the predetermined time period of the third fingerprint 202-3 being exposed to the fingerprint sensor 122. Otherwise, the logic 124 can deny enrollment to the fourth fingerprint 202-4 responsive to a determination that the fourth fingerprint 202-4 is not exposed to the at least one fingerprint sensor 122 within the predetermined time period of the third fingerprint 202-3 being exposed to the fingerprint sensor 122. Although this example time-based scheme 500-2 is depicted with an under-display fingerprint sensor 122 in the context of a user interface indication (e.g., as described with reference to FIG. 5-1), the example time-based scheme 500-2 can be implemented in other scenarios. For instance, the example time-based scheme 500-2 can be implemented with a fingerprint sensor 122 that is not layered with a display screen, with two fingerprint sensors 122 that are on the same or different sides of a device, and so forth.

Throughout this disclosure, examples are described where a computing system (e.g., a mobile phone, tablet computer, wearable device, or another type of computing system) may analyze information (e.g., fingerprint data) associated with a user, for example, the fingerprint 202, the representation 212, or the template 216 mentioned with respect to at least FIGS. 2 and 3. Further to the descriptions above, a user may be provided with controls allowing the user to make an election as to both if and when systems, programs, and/or features described herein may enable collection of information (e.g., information about a user's fingerprints or associated biometric templates), and if the user is sent content or communications from a server. The computing system can be configured to only use the information after the computing system receives explicit permission from the user of the computing system to use the data. For example, in situations where the computing device uses a primary user's fingerprint to authorize the enrollment of a trusted user's fingerprint, both the primary user and the trusted user may be provided with an opportunity to provide input to control whether programs or features of the computing device can collect and make use of the fingerprint data.

Further, individual users may have constant control over what programs can or cannot do with the information. In addition, information collected may be pretreated in one or more ways before it is transferred, stored, or otherwise used, so that personally identifiable information is removed. For example, a raw representation 212 of a fingerprint 202 can be converted into a mathematical template 216 that includes sufficient information for matching but from which the original fingerprint image cannot be reconstructed, with all such data accessed, manipulated, used, or stored in a secure, encrypted trusted execution environment (TEE). Thus, the users may have control over whether information is collected about the user and the user's device, and how such information, if collected, may be used by the computing device and/or a remote computing system.

Aspects of the described techniques may be implemented in, for example, hardware (e.g., fixed logic circuitry, a controller, a finite state machine, or a processor in conjunction with a memory), firmware, software, or some combination thereof. The techniques may be realized in conjunction with one or more of the apparatuses or components shown in FIGS. 1 to 6, which components may be further divided, combined, and so on. The devices and components of these figures generally represent hardware, such as electronic devices, PCBs, packaged modules, IC chips, components, or circuits; firmware; software; or a combination thereof. Thus, these figures illustrate some of the many possible systems or apparatuses capable of being produced using the described techniques.

For operations that are described herein, the orders in which the operations are shown and/or described are not intended to be construed as a limitation—unless context dictates otherwise (e.g., a primary user starting a predetermined time period by exposing a fingerprint thereof for a serial approach to joint fingerprint exposure). Instead, any number or combination of the described operations can be combined in any order to implement a given technique or an alternative one, including by combining operations from different portions of the description (e.g., from the description of different figures). Operations may also be omitted from or added to the described techniques. Further, described operations can be implemented in fully or partially overlapping manners.

### Additional Example Apparatuses and Electronic Devices

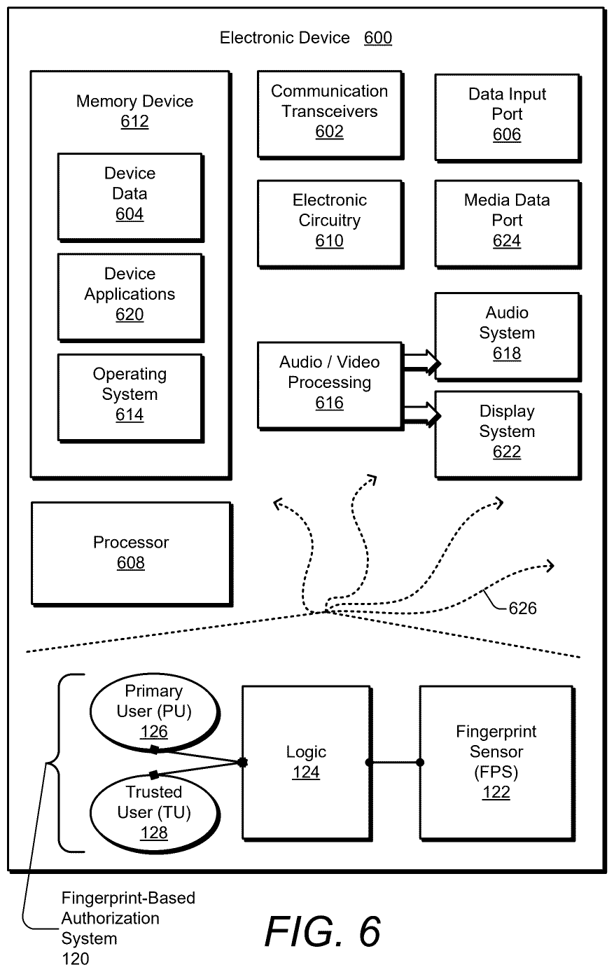

FIG. 6 illustrates various components of an example electronic device 600 that can implement trusted-user enrollment via fingerprinting with a fingerprint-based authorization system 120 in accordance with one or more described aspects. The electronic device 600 may be implemented as any one or combination of a fixed, mobile, stand-alone, or embedded device or in any form of a consumer, computer, portable, user, server, communication, phone, navigation, gaming, audio, camera, messaging, media playback, and/or other type of electronic device 600, such as the smartphone that is depicted in FIG. 1 as the apparatus 102. One or more of the illustrated components may be realized as discrete components or as integrated components on at least one integrated circuit of the electronic device 600 or separately or jointly in one or more packages of the electronic device 600.

The electronic device 600 can include one or more communication transceivers 602 that enable wired and/or wireless communication of device data 604, such as received data, transmitted data, or other information identified above. Example communication transceivers 602 include near-field communication (NFC) transceivers, wireless personal area network (PAN) (WPAN) radios compliant with various IEEE 802.15 (Bluetooth^{®}) standards, wireless local area network (LAN) (WLAN) radios compliant with any of the various IEEE 802.11 (Wi-Fi®) standards, wireless wide area network (WAN) (WWAN) radios (e.g., those that are 3GPP-compliant) for cellular telephony, wireless metropolitan area network (MAN) (WMAN) radios compliant with various IEEE 802.16 (WiMAX™) standards, infrared (IR) transceivers compliant with an Infrared Data Association (IrDA) protocol, and wired local area network (LAN) (WLAN) Ethernet transceivers.

The electronic device 600 may also include one or more data input ports 606 via which any type of data, media content, and/or other inputs can be received, such as user-selectable inputs, messages, applications, music, television content, recorded video content, and any other type of audio, video, and/or image data received from any content and/or data source, including a sensor like a microphone or a camera. The data input ports 606 may include USB ports, coaxial cable ports, fiber optic ports for optical fiber interconnects or cabling, and other serial or parallel connectors (including internal connectors) for flash memory, DVDs, CDs, and the like. These data input ports 606 may be used to couple the electronic device to components, peripherals, or accessories such as keyboards, microphones, cameras, or other sensors.

The electronic device 600 of this example includes at least one processor 608 (e.g., any one or more of application processors, microprocessors, digital-signal processors (DSPs), controllers, and the like), which can include a combined processor and memory system (e.g., implemented as part of an SoC), that processes (e.g., executes) computer-executable instructions to control operation of the device. The processor 608 may be implemented as an application processor, embedded controller, microcontroller, security processor, artificial intelligence (AI) accelerator, and the like. Generally, a processor or processing system may be implemented at least partially in hardware, which can include components of an integrated circuit or on-chip system, a digital signal processor (DSP), an application-specific integrated circuit (ASIC), a field programmable gate array (FPGA), a complex programmable logic device (CPLD), and other implementations in silicon and/or other materials.

Alternatively or additionally, the electronic device 600 can be implemented with any one or combination of electronic circuitry, which may include software, hardware, firmware, or fixed logic circuitry that is implemented in connection with processing and control circuits, which are generally indicated at 610 (as electronic circuitry 610). This electronic circuitry 610 can implement executable or hardware-based modules (not shown in FIG. 6), such as through processing/computer-executable instructions stored on computer-readable media, through logic circuitry and/or hardware (e.g., such as an FPGA), and so forth.

The electronic device 600 can include a system bus, interconnect, crossbar, data transfer system, switch fabric, or other communication fabric that couples the various components within the device. A system bus or interconnect can include any one or a combination of different bus structures, such as a memory bus or memory controller, a peripheral bus, a universal serial bus (USB), and/or a processor or local bus that utilizes any of a variety of bus architectures.

The electronic device 600 also includes one or more memory devices 612 that enable data storage, examples of which include random-access memory (RAM), non-volatile memory (e.g., read-only memory (ROM), flash memory, EPROM, and EEPROM), and a disk storage device. Thus, the memory device(s) 612 can be distributed across different logical storage levels of a system as well as at different physical components. The memory device(s) 612 provide data storage mechanisms to store the device data 604, other types of code and/or data, and various device applications 620 (e.g., software applications or programs). For example, an operating system 614 can be maintained as software instructions within the memory device 612 and executed by the processor 608.

In some implementations, the electronic device 600 also includes an audio and/or video processing system 616 that processes audio and/or video data and/or that passes through the audio and/or video data to an audio system 618 and/or to a display system 622 (e.g., a video buffer or a screen of a smartphone or camera). The audio system 618 and/or the display system 622 may include any devices that process, display, and/or otherwise render audio, video, display, and/or image data. Display data and audio signals can be communicated to an audio component and/or to a display component via an RF (radio-frequency) link, an S-video link, an HDMI (high-definition multimedia interface) link, a composite video link, a component video link, a DVI (digital video interface) link, an analog audio connection, a video bus, or another similar communication link, such as a media data port 624. In some implementations, the audio system 618 and/or the display system 622 are external or separate components of the electronic device 600. Alternatively, the display system 622, for example, can be an integrated component of the example electronic device 600, such as part of an integrated touch interface.

The electronic device 600 of FIG. 6 illustrates example implementations of the apparatus 102 of FIG. 1, of an apparatus that includes at least one fingerprint-based authorization system 120 as with any of the FIGS. 2 to 5-2, or some combination thereof. Accordingly, any one of the components illustrated in FIG. 6 may realize, incorporate, or support the operations of at least part of a fingerprint-based authorization system 120. As shown, the fingerprint-based authorization system 120 can include at least one fingerprint sensor 122 and at least one instance of logic 124 to enable enrollment of fingerprints 202 as a primary user 126 or a trusted user 128. As indicated by the arrows 626, multiple portions of the electronic device 600 may form part of, or operate in conjunction with, the fingerprint-based authorization system 120, like the data input port 606, the display system 622, the processor 608, the memory device 612, and electronic circuitry 610 generally.

Features described in the context of one example aspect (e.g., a method or an apparatus) may be used in combination with other example aspects (e.g., an apparatus or a method, respectively, or a different method or a different apparatus).

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, and a-b-b-c, or any other ordering or quantity of a, b, and c). Further, items represented in the accompanying figures and terms discussed herein may be indicative of one or more items or terms, and thus reference may be made interchangeably to singular or plural forms of the items and terms in this written description.

Although implementations for realizing trusted-user enrollment via fingerprinting have been described in language specific to certain features and/or methods, the subject of the appended claims is not necessarily limited to the specific features or methods described. Rather, the specific features and methods are disclosed as example implementations for realizing trusted-user enrollment via fingerprinting.

What is claimed is:

1. An apparatus for trusted-user enrollment via fingerprinting, the apparatus comprising:
one or more fingerprint sensors configured to:
sense one or more fingerprints; and
generate one or more representations respectively corresponding to the one or more fingerprints; and
logic coupled to the one or more fingerprint sensors and configured to:
detect a first fingerprint of the one or more fingerprints;
detect a second fingerprint of the one or more fingerprints, the second fingerprint different from the first fingerprint;
determine that the first fingerprint corresponds to a primary user;
determine that the first fingerprint and the second fingerprint are jointly exposed to the one or more fingerprint sensors; and
enroll, using the one or more representations, the second fingerprint as corresponding to a trusted user responsive to the determination that the first fingerprint corresponds to the primary user and the determination that the first fingerprint and the second fingerprint are jointly exposed to the one or more fingerprint sensors.

2. The apparatus of claim 1, wherein the logic is configured to:
deny enrollment to the second fingerprint responsive to a determination that the first fingerprint and the second fingerprint are not jointly exposed to the one or more fingerprint sensors.

3. The apparatus of claim 1, wherein the logic is configured to:
determine that the first fingerprint and the second fingerprint are simultaneously exposed to the one or more fingerprint sensors.

4. The apparatus of claim 3, wherein:
the one or more fingerprint sensors comprise one or more contact surfaces; and
the logic is configured to determine that the first fingerprint and the second fingerprint are simultaneously touching the one or more contact surfaces of the one or more fingerprint sensors.

5. The apparatus of claim 4, wherein the one or more fingerprint sensors comprise a single fingerprint sensor.

6. The apparatus of claim 5, wherein:
the apparatus has a front side and a rear side that is opposite the front side; and
the single fingerprint sensor is disposed on the rear side of the apparatus.

7. The apparatus of claim 6, wherein:
the front side comprises a display screen; and
the rear side lacks a display screen or comprises another display screen that is smaller than the display screen of the front side.

8. The apparatus of claim 1, wherein:
the apparatus has a front side and a rear side that is opposite the front side;
the one or more fingerprint sensors comprise a single fingerprint sensor that is disposed on the rear side of the apparatus;
the single fingerprint sensor is configured to be simultaneously exposed to at least two fingerprints, including the first fingerprint and the second fingerprint; and
the logic is configured to enroll the second fingerprint as corresponding to the trusted user with fewer than four scans of the second fingerprint.

9. The apparatus of claim 1, wherein the logic is configured to:
enroll the second fingerprint as corresponding to the trusted user with fewer than four scans of the second fingerprint responsive to the determination that the first fingerprint corresponds to the primary user and the determination that the first fingerprint and the second fingerprint are jointly exposed to the one or more fingerprint sensors.

10. The apparatus of claim 9, wherein the logic is configured to:
enroll the second fingerprint as corresponding to the trusted user with fewer than three scans of the second fingerprint responsive to the determination that the first fingerprint corresponds to the primary user and the determination that the first fingerprint and the second fingerprint are jointly exposed to the one or more fingerprint sensors.

11. The apparatus of claim 10, wherein:
the logic is configured, as part of enrolling the second fingerprint as corresponding to the trusted user with fewer than three scans of the second fingerprint, to generate a template for the second fingerprint using a representation of each scan from the fewer than three scans of the second fingerprint; and
the logic is configured to update the template using one or more additional scans of the second fingerprint as the trusted user authenticates with the second fingerprint over time.

12. The apparatus of claim 1, wherein the logic is configured to:
bound the enrollment of the second fingerprint as corresponding to the trusted user responsive to at least one of a temporal constraint or a geospatial constraint.

13. The apparatus of claim 12, wherein the logic is configured to:
terminate operational authorization for the trusted user if the temporal constraint is violated.

14. The apparatus of claim 12, wherein the logic is configured to:
terminate operational authorization for the trusted user if the geospatial constraint is violated.

15. The apparatus of claim 14, wherein:
the geospatial constraint is responsive to a geospatial position of the apparatus when the enrollment of the second fingerprint is performed and a current geospatial position of the apparatus.

16. The apparatus of claim 14, wherein:
the geospatial constraint is responsive to a current geospatial position of another apparatus that is linked to the primary user and a current geospatial position of the apparatus.

17. The apparatus of claim 1, further comprising:
at least one display screen comprising multiple pixels, wherein:
the one or more fingerprint sensors and the at least one display screen are layered together such that the multiple pixels of the display screen are visible where the one or more fingerprint sensors are configured to sense the one or more fingerprints; and
the logic is configured to:
display one or more rings indicating one or more boundaries around the one or more fingerprint sensors; and
display, within the one or more rings, one or more icons indicating that at least one fingerprint can be sensed within the one or more rings.

18. The apparatus of claim 1, wherein the logic is configured to:
activate a trusted-user enrollment mode that enables sequential fingerprint sensing; and
responsive to the trusted-user enrollment mode being activated:
detect a third fingerprint of the one or more fingerprints;
detect a fourth fingerprint of the one or more fingerprints;
determine that the third fingerprint corresponds to the primary user;
determine that the fourth fingerprint is exposed to the one or more fingerprint sensors within a predetermined time period of the third fingerprint being exposed to the one or more fingerprint sensors; and
enroll the fourth fingerprint as corresponding to a trusted user responsive to the determination that the third fingerprint corresponds to the primary user and the determination that the fourth fingerprint is exposed to the one or more fingerprint sensors within the predetermined time period of the third fingerprint being exposed to the one or more fingerprint sensors; or
deny enrollment to the fourth fingerprint responsive to a determination that the fourth fingerprint is not exposed to the one or more fingerprint sensors within the predetermined time period of the third fingerprint being exposed to the one or more fingerprint sensors.

19. A method for trusted-user enrollment via fingerprinting, the method comprising:
sensing, by one or more fingerprint sensors, one or more fingerprints;
generating, by the one or more fingerprint sensors, one or more representations respectively corresponding to the one or more fingerprints;
detecting, by logic, a first fingerprint of the one or more fingerprints;
detecting, by the logic, a second fingerprint of the one or more fingerprints, the second fingerprint different from the first fingerprint;
determining, by the logic, that the first fingerprint corresponds to a primary user;
determining, by the logic, that the first fingerprint and the second fingerprint are jointly exposed to the one or more fingerprint sensors; and
enrolling, by the logic and using the one or more representations, the second fingerprint as corresponding to a trusted user responsive to the determining that the first fingerprint corresponds to the primary user and the determining that the first fingerprint and the second fingerprint are jointly exposed to the one or more fingerprint sensors.

20. A non-transitory computer-readable medium storing instructions that, when executed by one or more processors, cause the one or more processors to perform operations comprising:
sensing, using one or more fingerprint sensors, one or more fingerprints;
generating, using the one or more fingerprint sensors, one or more representations respectively corresponding to the one or more fingerprints;
detecting a first fingerprint of the one or more fingerprints;
detecting a second fingerprint of the one or more fingerprints, the second fingerprint different from the first fingerprint;
determining that the first fingerprint corresponds to a primary user;
determining that the first fingerprint and the second fingerprint are jointly exposed to the one or more fingerprint sensors; and
enrolling, using the one or more representations, the second fingerprint as corresponding to a trusted user responsive to the determining that the first fingerprint corresponds to the primary user and the determining that the first fingerprint and the second fingerprint are jointly exposed to the one or more fingerprint sensors.
